(19) United States
(12) Patent Application Publication
(10) Pub. No.: US 2026/0162869 A1
(43) Pub. Date: Jun. 11, 2026

(54) Transformer Pad with Secondary Containment for Transformer Oil

(71) Applicant: Dominion Energy, Inc, Richmond, VA (US)

(72) Inventors: Norman Dean Combs, Mechanicsville, VA (US); Martin O'Baker, Richmond, VA (US)

(73) Assignee: Dominion Energy, Inc., Richmond, VA (US)

(21) Appl. No.: 18/977,535

(22) Filed: Dec. 11, 2024

(51) Int. Cl. H01F 27/14; H01F 27/02

(52) U.S. Cl. CPC H01F 27/14; H01F 27/025

(57) ABSTRACT

Transformers reduce voltage of the power distribution for use by the ultimate user. These transformers include transformer oil that provides electrical insulation and functions as a coolant. A transformer assembly and/or a transformer pad has a secondary containment sump configured to collect transformer oil that may leak from a transformer. The transformer assemblies or transformer pads may also have a second sump to collect water from the bottom of the secondary containment sump or a petroleum plug to allow water to be released from the secondary containment sump but not oil or other petroleum fluids.

### FIELD OF THE INVENTION

Embodiments of transformer assembly and/or a transformer pad define a secondary containment sump configured to collect transformer oil that may leak from a transformer. The transformer assemblies or transformer pads may also comprise a second sump to collect water from the bottom of the secondary containment sump or a petroleum plug to allow water to be released from the secondary containment sump but not oil or other petroleum fluids.

### BACKGROUND

The electrical grid distributes electricity from one or more centralized sources of electric power to the residential and commercial users of the generated electricity. The centralized source of electric power may be, but are not limited to, coal or gas fired electrical power plants, solar energy farms, wind energy farms, or hydroelectric power generators. The electricity is generated at the source in high voltages for distribution and consumed residentially and commercially at lower voltages. The high voltage electricity is present in power lines so the transmission of power over long distances in the electric grid may be accomplished more efficiently with less line losses and at greater capacity to meet the demands of modern society. To be usable and safer electric power for residential and commercial applications, the high voltage electricity must pass through a transformer which converts this high voltage electricity to a lower more suitable and safer voltage.

A transformer is an electrical device that takes an input voltage and changes it to a different output voltage. This change can either be an increase or a decrease in voltage.

Transformers are typically filled with transformer oil for various purposes. For example, the transformer oil protects the transformer's components by insulating them from each other and from grounded metal parts. Transformer oil also absorbs and dissipates heat generated by the transformer's core and coil during voltage conversions and can extinguish any arcs that may occur during switching operations. Transformer oil can be mineral-based or synthetic. Mineral-based transformer oils are made by refining crude oils and synthetic transformer oils are made through chemical processes.

A transformer may fail for various reasons and leak its transformer oil. When the transformer oil level drops below a specified level in the transformer, the transformer's internal fuse will melt shutting down the transformer and resulting in an outage to the customers served by that transformer. Transformer oil leaks may cause environmental damage and fire hazards. For example, the oil can leak into soil and groundwater, which may pollute the ecosystem and transformer oil on the ground around the transformer can create a fire hazard. Significant transformer oil spills as is the case for other chemical spills may require reporting to the state and/or federal environmental agencies.

Since there are so many transformers currently in service that there is an existing need for a secondary containment system for electrical transformers that can collect leaked oil to prevent environmental damage and allow efficient cleanup during transformer repair or servicing.

### SUMMARY

Small electrical transformers may be installed on a transformer pad on the ground in residential and commercial consumers areas to reduce the distribution voltage to a consumer usage voltage. These ground installed transformers comprise a transformer oil. Surprisingly, transformer oil spills from such small transformers are more common than transformer oil spills from large transformers. For significant transformer oil leaks, the transformer's internal fuse will likely melt causing the transformer to shut down and an outage to the customers being served by the transformer. With conventional transformer assemblies, the leaked transformer oil is released from the transformer, the transformer housing, and spills off the edges of the transformer pad onto the ground surrounding the transformer pad. This oil spill may result in a state and/or federal reporting requirements and environmental cleanup.

Embodiments of the transformer assembly can capture leaking transformer oil in a secondary containment sump to prevent environment damage and avoid environmental reporting requirements. A transformer oil leak may still result in an electrical outage for the consumer that is connected to the transformer, but the transformer oil will be retained in the oil sump in the transformer assembly for efficient clean up and removal. The electrical utility will be notified of the transformer failure and potential oil release through reported consumer outages from the affected consumers. Since there will be no or an insignificant amount of oil lost to the environment, an environmental incident report may be avoided and no environmental damage has occurred.

An embodiment of a transformer assembly that significantly reduces environmental damage of transformer oil spill may comprise a transformer oil containment pad. The transformer oil containment pad comprises or defines a first sump or oil sump. The first sump may be a secondary containment sump for the transformer oil and be defined in the transformer pad. The first sump may comprise a volume that is greater than a volume of a transformer oil within the functioning transformer such that all the oil, if released, may be contained within the first sump.

Embodiments of the transformer assembly may also comprise a second sump.

The second sump may collect water from rain or water transferred from the bottom of the first sump.

The first sump and the second sump may be in fluid communication by a drain tube. In one embodiment, a drain tube is in fluid communication between a bottom portion of the first sump and a top portion of the second sump.

Embodiments of the transformer assembly may also comprise a transformer housing. The transformer housing covers the transformer, at least partially covers the first sump, and at least partially covers the second sump. The transformer housing may comprise an access door to clean the sumps and repair or replace the transformer.

Aspects of the transformer assembly and the transformer pad are presented in various embodiments, however one skilled in the art will understand variations and interchangeability of the components of the various embodiments which are intended to be included in the scope of the invention.

### BRIEF DESCRIPTION OF THE FIGURES

FIG. 1 depicts a portion of the transformer assembly including a transformer pad, a water sump, a solid cover, a grate cover, and the drain tube providing fluid communication between the oil sump and the water sump;

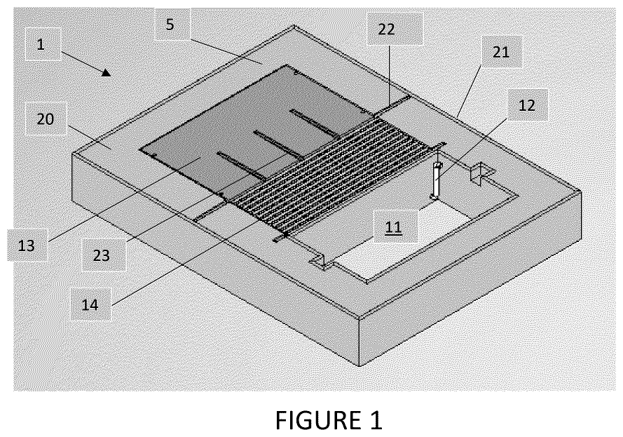

FIG. 2 depicts the portion of the transformer assembly of FIG. 1 with the solid cover and the grate cover removed and showing the oil sump; and

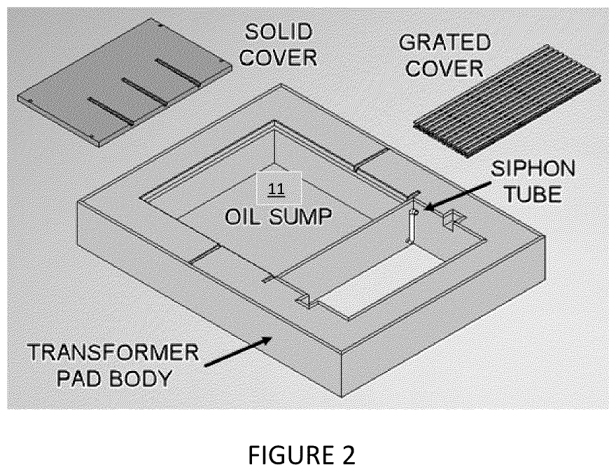

FIG. 3 depicts the transformer assembly of FIG. 1 with the transformer housing on the transformer pad with a hinged access door in the open configuration.

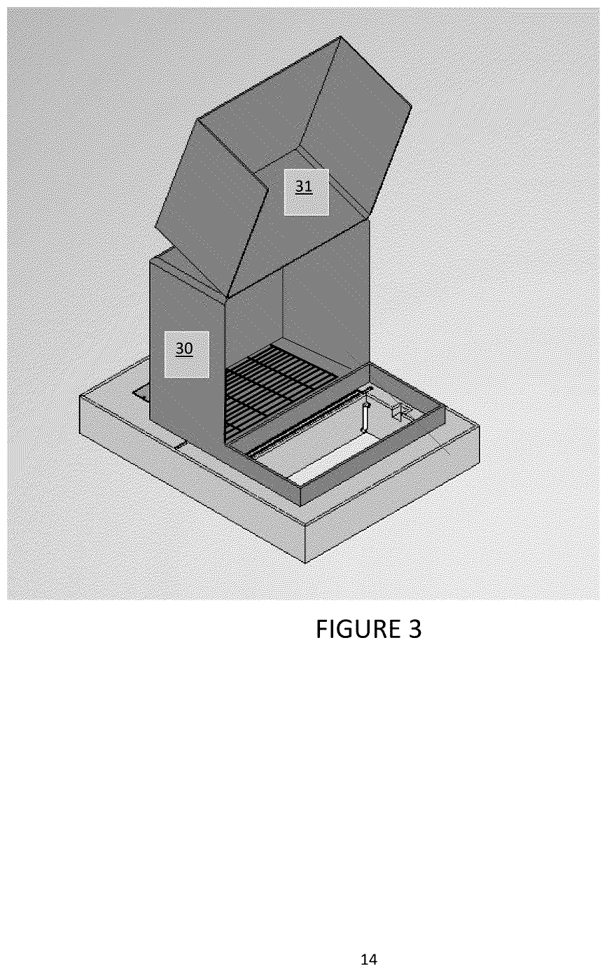

### DESCRIPTION

Embodiments of a transformer assembly are configured to capture leaking transformer oil in a secondary containment oil sump to prevent environment damage and avoid environmental reporting requirements of an uncontained oil spill. A transformer oil leak may still result in an electrical outage the consumer due to the failure of the transformer but the leaked transformer oil will be safely captured in the oil sump.

An embodiment of a transformer assembly comprises a transformer pad comprising or defining a secondary containment for leaked transformer oil (first sump). Other embodiments of the transformer oil pad may comprise or define both a first sump and a second sump or a first sump and a petroleum plug or other oil barrier that allows water to pass through but absorbs oil and prevents oil leaking from the first sump. The transformer pad made be constructed from any appropriate material such as concrete, composite material, or plastic.

The oil sump is configured to contain the entire volume of oil contained in the transformer. The top surface of the pad body may be sloped toward the oil sump and may additionally comprise channels that direct released transformer oil to the oi sump. Further, an elevated rim may surround a potential spill area on the outside perimeter of the top face of the sump to keep spilled oil from going off the sides. These features reduce the chance that any transformer oil will reach the area surrounding the transformer pad.

The first sump may be a secondary containment sump to receive and contain any leaked transformer oil. The first sump may be configured underneath the transformer. The first sump may be defined by the transformer pad or removably inserted or otherwise connected to the transformer pad. In order to contain the transformer oil from a release of all the oil, the first sump may be configured to have a volume that is greater than a volume of a transformer oil within the functioning transformer installed in the transformer assembly such that all the oil can be contained within the first sump. In some embodiments, the first sump may have between a 5% and 25% greater volume than the volume of oil in the transformer.

The first sump and the second sump or the first sump and the petroleum plug are in fluid communication by a drain tube. In one embodiment, a drain tube is in fluid communication between a bottom portion of the first sump and a top portion of the second sump.

Embodiments of the transformer assembly operate to provide secondary containment for the transformer oil and means for separating water from the leaked transformer oil. Fluids within the footprint of the transformer pad area, including rainwater, are diverted inward to the sump or sumps in the transformer pad. In a conventional transformer pad without secondary containment, the fluids flow off the sides of the pad and the transformer housing to the surrounding environment. Once the fluids are in the sump or sumps, the water and any oil will separate tend to separate. Transformer oil has a density that is lower than the density of water resulting in separation and the transformer oil floating in an oil stratified layer on top of the water layer. The water layer on the bottom of the sump may be separated from the oil on top by draining through the drain tube positioned in a bottom portion of the oil sump or the first sump.

In such an embodiment, a drain tube may be located in an oil sump outlet at the bottom portion of the oil sump or the first sump. In one embodiment, the transformer assembly comprises a water sump or the second sump. In such an embodiment, the top of the drain tube may be located just below the oil sumps high fluid level and below the top of the oil sump, thus allowing the water to escape the first sump to the second sump and the oil to remain in the first sump.

In another embodiment, the transformer assembly comprises a petroleum plug. A petroleum plug allows is installed in the drain tube from the bottom portion of the first sump. A petroleum plug is a device that allows water to pass through it but will prevent oil from passing through. A conventional petroleum plug comprises a polymeric material that expands and solidifies upon contact with petroleum products such as transformer oil. The solidified polymer plugs the pipe or drain tube to prevent the release of any further oils. Until the polymer is solidified, water may pass through without solidifying or plugging the drainpipe.

Embodiments of the transformer assembly also may comprise a transformer housing. The transformer housing covers the transformer, at least partially covers the first sump, and at least partially covers the second sump. The transformer housing may comprise an access door to clean the sumps and repair or replace the transformer.

An embodiment of the transformer assembly comprises four main components as shown in the figures.

### Transformer Oil Containment Pad

The transformer oil containment pad 5 is a foundation and support for the transformer but also defines the first sump 10. In some embodiments, the first sump 10 is an oil containment sump or oil sump. In some residential applications, a transformer comprises twenty-one gallons of transformer oil and, therefore, the transformer assembly comprises an oil sump 10 capable of holding at least twenty-one gallons of oil. Any oil or other liquid spilled or otherwise deposited on a top surface 20 of the transformer oil containment pad 5 rolls into the first sump 10 or is channeled to the oil sump 10 through oil sump drainage grooves 22 defined in the top surface 20 of the transformer pad. In some embodiments, an outer perimeter of the top surface 20 of the transformer oil containment pad 5 comprises a raised edge or lip 21 to keep spilled oil or rainwater from going off the exterior sides of the transformer oil containment pad 5 to the surrounding area.

### Drain Tube

A drain tube 12 provides fluid communication from an inner volume of the first sump 10 with a water drainage space. The water drainage space may be, but is not limited to, a second sump (water sump) 11 or a petroleum plug (not shown), for example. The first sump 10 may contain both oils and water in stratified layers with a water layer being the bottom layer and the oil layer being a top layer. In some embodiments, the drain tube 12 is in fluid communication with a bottom portion of the first sump 10 and the bottom layer so the drain tube allows water to escape from the oil sump. The bottom portion of the first sump may be defined as the potion of the first sump at the bottom that comprises fifteen percent of the volume of the entire sump.

In an embodiment of the transformer assembly with a second sump 11, an outlet of the drain tube 14 is within the second sump 11 and the outlet is elevated above the inlet of the drain tube 14 to a position below the top surface of the transformer pad. Water from the water layer is pushed into the drain tube 14 and then out of the outlet of the drain tube 14 into the second sump from the head pressure of the oil layer floating on top layer during an oil spill event. The outlet of the drain tube 14 may also be used as a connection for an external pump to empty the oil sump with the transformer still in place. In such an embodiment, the outlet of the drain tube 14 may comprise a connection or fitting to connect additional piping or a pump suction to the drain tube 14.

### Solid Cover

The transformer assembly may comprise a solid cover 13 over at least a portion of the first sump. The solid cover 13 may be set into a recessed edge 6 defined in the top surface 20 of the transformer containment oil pad 5. In some embodiments, a top surface of the solid cover 13 is substantially even with the top surface 20 of the transformer containment oil pad 5. The solid cover 13 is at least partially covered by a transformer cover 30. Removal of the solid cover provides access to clean out the first sump 10. The solid cover 13 may be removed if there is no transformer on the transformer containment oil pad 5. In some embodiments, the solid cover 13 may comprise at least one solid cover drain groove 23 to channel oil into the sump in the event of a leaking transformer or other liquid present on the solid cover. The solid cover may be reversibly connected to the transformer containment oil pad 5 by bolts or other fasteners. The cover 30 may comprise an access door 31 hingedly connected to the housing 30 to provide access to the transformer and the second sump 11 or petroleum plug.

### Grate Cover

The transformer assembly may comprise a grate cover 14. The grate cover 14 is at least partially covered by the footprint of the transformer. Often, bushings where the conductors terminate on the transformer are the source of a leak. In the event of a leaking bushing, the oil will flow down the face of the transformer and directly into the first sump 10 through the grate cover 14. The grate cover may not be bolted on to the transformer pad but may held in place by being received in the recess edge 5 into the top face of the transformer pad 20 and configured to fit within this area. Once the failed transformer has been removed from the pad, the grate cover 14 can be easily removed for direct pumping and cleaning of the oil sump 10. In some embodiments, the grate cover 14 and the solid cover 13 cover the oil sump 10.

In some embodiments, the second sump is not covered by either the grate cover or the solid cover and may be directly accessed by opening the transformer cover access door.

The embodiments of the described transformer assembly and methods are not limited to the embodiments, components, method steps, and materials disclosed herein as such components, process steps, and materials may vary. Moreover, the terminology employed herein is used to describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be affected within the scope of the invention as defined in the specification and the appended claims. Accordingly, the scope of the various embodiments of the present invention should not be limited to the above discussed embodiments and should only be defined by the following claims and all equivalents.

1. A transformer assembly, comprising:
a transformer oil containment pad, wherein the transformer oil containment pad defines a first sump and a second sump;
a transformer housing, wherein the transformer housing comprises an access door and the transformer housing at least partially covers the first sump and at least partially covers the second sump;
a drain tube in fluid communication with a bottom portion of the first sump and a top portion of the second sump;
a solid cover, wherein the solid cover covers a first portion of first sump;
a grate cover, wherein the grate cover covers a second portion of first sump.

2. The transformer assembly of claim 1, comprising a volume of a transformer oil, wherein the first sump is a secondary containment reservoir for the transformer oil.

3. The transformer assembly of claim 1, wherein the first sump and the second sump are separated by a sump divider wall.

4. The transformer assembly of claim 1, wherein the transformer assembly comprises a volume of transformer oil and a volume of the first sump is greater than the volume of transformer oil.

5. The transformer assembly of claim 4, wherein the second sump collects water pushed out of the first sump by transformer oil in the first sump.

6. The transformer assembly of claim 1, wherein the transformer housing completely covers the second sump.

7. The transformer assembly of claim 1, wherein drain tube extends through the sump divider wall from the first sump to the second sump.

8. The transformer assembly of claim 1, wherein the grate cover is completely within the transformer housing.

9. The transformer assembly of claim 1, wherein the transformer assembly comprises a transformer.

10. The transformer assembly of claim 9, wherein the transformer is connected to the transformer oil containment pad over the grate cover of the first sump.

11. The transformer assembly of claim 1, wherein the access door has an open configuration and a closed configuration, with the access door is in the closed configuration the access door covers the grate cover and with the access door is in an open configuration the grate cover is accessible from outside the transformer housing.

12. A transformer assembly, comprising:
a transformer pad defining a first sump and a second sump;
a transformer;
a drain tube in fluid communication with a bottom portion of the first sump and a top portion of the second sump;
a transformer housing partially covering the first sump and completely covering the second sump, wherein the transformer housing has a hinged access door for accessing the second sump.

13. The transformer assembly of claim 12, comprises a volume of a transformer oil, wherein the first sump is a secondary containment reservoir for the transformer oil.

14. The transformer assembly of claim 12, wherein the first sump and the second sump are separated by a sump divider wall.

15. The transformer assembly of claim 12, wherein the transformer assembly comprises a volume of transformer oil and a volume of the first sump is greater than the volume of transformer oil.
